(19) United States
(12) Patent Application Publication
(10) Pub. No.: US 2024/0381367 A1
(43) Pub. Date: Nov. 14, 2024

(54) Control Channel Monitoring based on Hybrid ARQ Considerations

(71) Applicant: Telefonaktiebolaget LM Ericsson (publ), Stockholm (SE)

(72) Inventors: Ilmiawan Shubhi, Malmö (SE); Ajit Nimbalker, Dublin, CA (US); Ravikiran Nory, San José, CA (US)

(21) Appl. No.: 18/692,047

(22) PCT Filed: Sep. 30, 2022
(86) PCT No.: PCT/SE2022/050870

§ 371 Date: Mar. 14, 2024

Related U.S. Application Data
(60) Provisional application No. 63/251,356, filed on Oct. 1, 2021.

(51) Int. Cl. H04W 72/23; H04L 1/1867

(52) U.S. Cl. CPC H04W 72/23; H04L 1/1896

(57) ABSTRACT

The disclosure relates to a method for a UE configured to operate in a RAN. The method comprises receiving a PDCCH monitoring configuration that includes respective parameters for a plurality of PDCCH monitoring states. It also comprises, while operating in a first one of the PDCCH monitoring states, receiving an indication of a second one of the PDCCH monitoring states, and performing one of the following: selectively entering the second PDCCH monitoring state based on whether decoding of a PDSCH transmission from the RAN node was successful, or selectively exiting the second PDCCH monitoring state based on whether decoding of the PDSCH transmission from the RAN node was successful. A corresponding method for a RAN node and the corresponding UE and apparatus are also described.

### TECHNICAL FIELD

The present disclosure generally relates to wireless communication networks, and particularly relates to techniques for reducing energy consumed by a user equipment (UE) while monitoring a control channel in a wireless network.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 shows a high-level view of an exemplary 5G network architecture, including a Next Generation Radio Access Network (NG-RAN) 199 and a 5G Core (5GC) 198. As shown in the figure, NG-RAN 299 can include gNBs 110 (e.g., 110a,b) and ng-eNBs 120 (e.g., 120a,b) that are interconnected with each other via respective Xn interfaces. The gNBs and ng-eNBs are also connected via the NG interfaces to 5GC 298, more specifically to the AMF (Access and Mobility Management Function) 130 (e.g., AMFs 130a,b) via respective NG-C interfaces and to the UPF (User Plane Function) 140 (e.g., UPFs 140a,b) via respective NG-U interfaces. Moreover, the AMFs 230a,b can communicate with one or more policy control functions (PCFs, e.g., PCFs 250a,b) and network exposure functions (NEFs, e.g., NEFs 160a,b).

Each of the gNBs 110 can support the NR radio interface including frequency division duplexing (FDD), time division duplexing (TDD), or a combination thereof. Each of ng-eNBs 120 can support the fourth-generation (4G) Long-Term Evolution (LTE) radio interface. Unlike conventional LTE eNBs, however, ng-eNBs 120 connect to the 5GC via the NG interface. Each of the gNBs and ng-eNBs can serve a geographic coverage area including one more cells, such as cells 111a-b and 121a-b shown in FIG. 1. Depending on the particular cell in which it is located, a UE 205 can communicate with the gNB or ng-eNB serving that particular cell via the NR or LTE radio interface, respectively. Although FIG. 1 shows gNBs and ng-eNBs separately, it is also possible that a single NG-RAN node provides both types of functionality.

5G/NR technology shares many similarities with LTE. For example, NR uses CP-OFDM (Cyclic Prefix Orthogonal Frequency Division Multiplexing) in the downlink (DL) and both CP-OFDM and Discrete Fourier Transform (DFT)-spread OFDM (DFT-S-OFDM) in the uplink (UL). As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a DL beam is a coverage area of a network-transmitted reference signal (RS) that may be measured or monitored by a UE.

FIG. 2 shows an exemplary configuration of NR user plane (UP) and control plane (CP) protocol stacks between a UE (210), a gNB (220), and an AMF (220), such as those shown in FIG. 1. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The Radio Resource Control (RRC) layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a physical downlink control channel (PDCCH) for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to an LTE “suspended” condition.

DRX functionality is also used by RRC_CONNECTED UEs. This allows a UE to turn off at least some of its receiver circuitry when no incoming data is expected, which helps reduce the energy consumption. When configured, the DRX functionality controls the expected UE behavior in terms of reception and processing of transmissions. Similar to RRC_IDLE DRX, RRC_CONNECTED DRX includes an active time (also referred to as active time state or ACTIVE state), in which the UE is expected to receive and process incoming transmissions as appropriate. For example, the UE is expected to decode PDCCH, process grants, etc. When the UE is not in active time (i.e., in inactive time), there is no expectation on the UE receiving and processing transmissions. That is, the base station cannot assume that the UE will be listening to DL transmissions. The DRX configuration defines the transitions between states. Note that a UE's RRC state is independent of its DRX state, such that a UE stays in its current RRC state when changing between DRX active and inactive times.

Typically, UEs that are not in active time turn off some of their components and enter a reduced-energy (i.e., sleeping) mode. To ensure that the UE switches regularly to active time (i.e., wakes up), a DRX cycle is defined. This DRX cycle is controlled by two parameters: a periodicity, which controls how frequently the UE switches to active time; and a duration, which controls for how long the UE remains in active time in each instance.

PDCCH monitoring during active time is one of the most energy-consuming operations performed by a UE. In fact, monitoring for PDCCH in the absence of data may be the dominant source of energy consumption in enhanced mobile broadband (eMBB) in typical scenarios. Accordingly, techniques that reduce unnecessary PDCCH monitoring occasions (MOs) and allow a UE to sleep more often and/or wake-up only when required can be beneficial.

### SUMMARY

Embodiments of the present disclosure provide specific improvements to communication between UEs and network nodes in a wireless network, such as by providing, enabling, and/or facilitating solutions to overcome exemplary problems summarized above and described in more detail below.

Embodiments include methods (e.g., procedures) for a UE configured for operation in a radio access network (RAN).

These exemplary methods can include receiving, from a RAN node, a PDCCH monitoring configuration that includes respective parameters for a plurality of PDCCH monitoring states.

These exemplary methods can also include, while operating in a first one of the PDCCH monitoring states, receiving from the RAN node an indication of a second one of the PDCCH monitoring states. These exemplary methods can also include one of the following operations:
selectively entering the second PDCCH monitoring state based on whether decoding of a physical downlink shared channel (PDSCH) transmission from the RAN node was successful, or
selectively exiting the second PDCCH monitoring state based on whether decoding of the PDSCH transmission from the RAN node was successful.

In some embodiments, the indication is received in downlink control information (DCI) and the DCI also includes scheduling information for the PDSCH transmission. In some variants, the configuration is received in an RRC message.

In some embodiments, the PDCCH monitoring configuration is applicable to one of the following: only the cell in which the PDCCH monitoring configuration was received; or a plurality of cells served by the RAN node, including the cell in which the PDCCH monitoring configuration was received.

In some embodiments, the parameters for each of the PDCCH monitoring states includes one or more of the following: a skipping duration to refrain from PDCCH monitoring; and a search space set group (SSSG) to use for PDCCH monitoring. In some variants, the indication may be an index or a bitfield that can have one of a plurality of values that respectively correspond to one of the following:
a plurality of different SSSGs;
a plurality of different skipping durations; or
a first plurality of different SSSGs and a second plurality of different skipping durations.
   In some variants, one of the different skipping durations is no skipping of PDCCH monitoring.

In some embodiments, these exemplary methods can also receiving and attempting to decode the PDSCH transmission, and transmit HARQ feedback having a value that indicates whether the decoding of the PDSCH transmission was successful.

In some embodiments, these exemplary methods can also include entering the second PDCCH monitoring state upon receiving the indication. In such embodiments, selectively exiting the second PDCCH monitoring state can include the following operations:
remaining in the second PDCCH monitoring state in response to the decoding of the PDSCH transmission being successful; and
exiting the second PDCCH monitoring state and entering the first PDCCH monitoring state in response to the PDSCH decoding being unsuccessful.
   In some of these embodiments, exiting the second PDCCH monitoring state and entering the first PDCCH monitoring state occurs a predetermined delay after transmitting the HARQ feedback.

In some of these embodiments, the second PDCCH monitoring state includes a skipping duration and remaining in the second PDCCH monitoring state is until the end of the skipping duration. Additionally, selectively exiting the second PDCCH monitoring state also includes, at the end of the skipping duration, exiting the second PDCCH monitoring state and entering the first PDCCH monitoring state.

In other embodiments, selectively entering the second PDCCH monitoring state can include the following operations:
entering the second PDCCH monitoring state in response to the decoding of the PDSCH transmission being successful; and
remaining in the first PDCCH monitoring state in response to the PDSCH decoding being unsuccessful.
   In some of these embodiments, entering the second PDCCH monitoring state occurs a predetermined delay after transmitting the HARQ feedback.

In some of these embodiments, the second PDCCH monitoring state includes a skipping duration and selectively entering the second PDCCH monitoring state also includes, at the end of the skipping duration, exiting the second PDCCH monitoring state and entering the first PDCCH monitoring state.

Embodiments include methods (e.g., procedures) for a RAN node configured to communicate with UEs. Generally, these methods are complementary to the methods for a UE that were summarized above.

These exemplary methods can include sending, to a UE, a PDCCH monitoring configuration that includes respective parameters for a plurality of PDCCH monitoring states. These exemplary methods can also include, while the UE is operating in a first one of the PDCCH monitoring states, sending to the UE an indication of a second one of the PDCCH monitoring states. These exemplary methods can also include transmitting a PDSCH transmission to the UE. The UE's transition between the first PDCCH monitoring state and the second PDCCH monitoring state is based on whether the UE's decoding of the PDSCH transmission was successful or unsuccessful.

In some embodiments, the indication is sent in DCI, and the DCI also includes scheduling information for the PDSCH transmission. In some variants, the configuration is received in an RRC message. In some embodiments, the PDCCH monitoring configuration is applicable to one of the following: only the cell in which the PDCCH monitoring configuration was received; or a plurality of cells served by the RAN node, including the cell in which the PDCCH monitoring configuration was received.

In some embodiments, the parameters for each of the PDCCH monitoring states includes one or more of the following: a skipping duration to refrain from PDCCH monitoring; and a search space set group (SSSG) to use for PDCCH monitoring. In some variants, the indication may be an index or a bitfield that can have one of a plurality of values that respectively correspond to one of the following:
a plurality of different SSSGs;
a plurality of different skipping durations; or
a first plurality of different SSSGs and a second plurality of different skipping durations.
   In some variants, one of the different skipping durations is no skipping of PDCCH monitoring.

In some embodiments, these exemplary methods can also include receiving, from the UE, HARQ feedback having a value that indicates whether the UE's decoding of the PDSCH was successful.

Other embodiments include UEs (e.g., wireless devices, IoT devices, etc.) and RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or network nodes to perform operations corresponding to any of the exemplary methods described herein.

These and other embodiments described herein can facilitate reduced UE energy consumption via PDCCH monitoring state transitions, while reducing and/or minimizing the impact of such transitions on data throughput and/or latency. This can benefit applications and end users by providing increased UE battery life (i.e., between charges) and more consistent data throughput.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level views of an exemplary 5G/NR network architecture.

FIG. 2 shows an exemplary configuration of NR UP and CP protocol stacks.

FIG. 3 shows an exemplary frequency-domain configuration for an NR UE.

FIG. 4 shows an exemplary time-frequency resource grid for an NR slot.

FIG. 5 shows a flow diagram of an exemplary method (e.g., procedure) for a UE (e.g., wireless device), according to various embodiments of the present disclosure.

FIG. 6 shows a flow diagram of an exemplary method (e.g., procedure) for a RAN node (e.g., base station), according to various embodiments of the present disclosure.

FIG. 7 shows a communication system according to various embodiments of the present disclosure.

FIG. 8 shows a UE according to various embodiments of the present disclosure.

FIG. 9 shows a network node according to various embodiments of the present disclosure.

FIG. 10 shows host computing system according to various embodiments of the present disclosure.

FIG. 11 is a block diagram of a virtualization environment in which functions implemented by some embodiments of the present disclosure may be virtualized.

FIG. 12 illustrates communication between a host computing system, a network node, and a UE via multiple connections, at least one of which is wireless, according to various embodiments of the present disclosure.

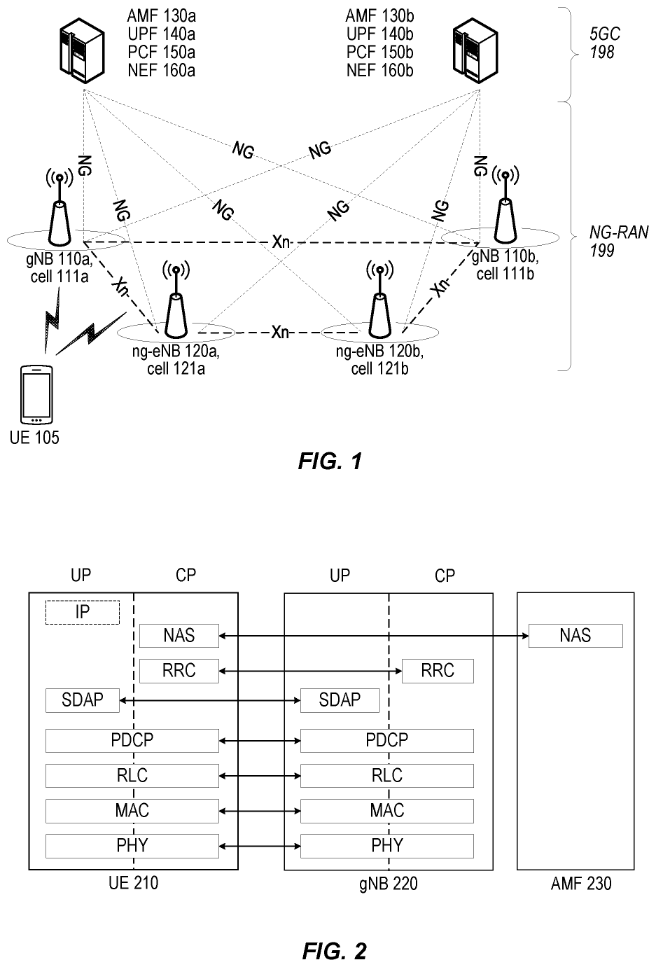

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a radio access node or a wireless device.”
Node: As used herein, a “node” can be a network node or a wireless device.
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR and possibly also to a future 6G system) beams may be used instead of cells and, as such, concepts described herein apply equally to both cells and beams.

As briefly mentioned above, PDCCH monitoring during active time is one of the most energy-consuming operations performed by a UE. In fact, monitoring for PDCCH in the absence of data may be the dominant source of energy consumption in enhanced mobile broadband (eMBB) in typical scenarios. This is discussed in more detail below.

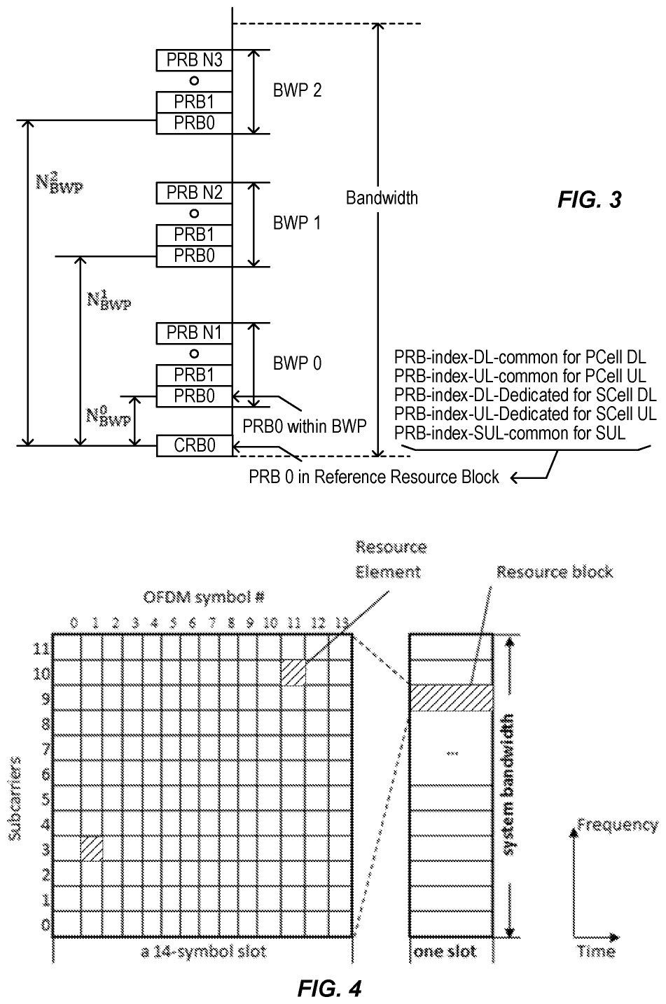

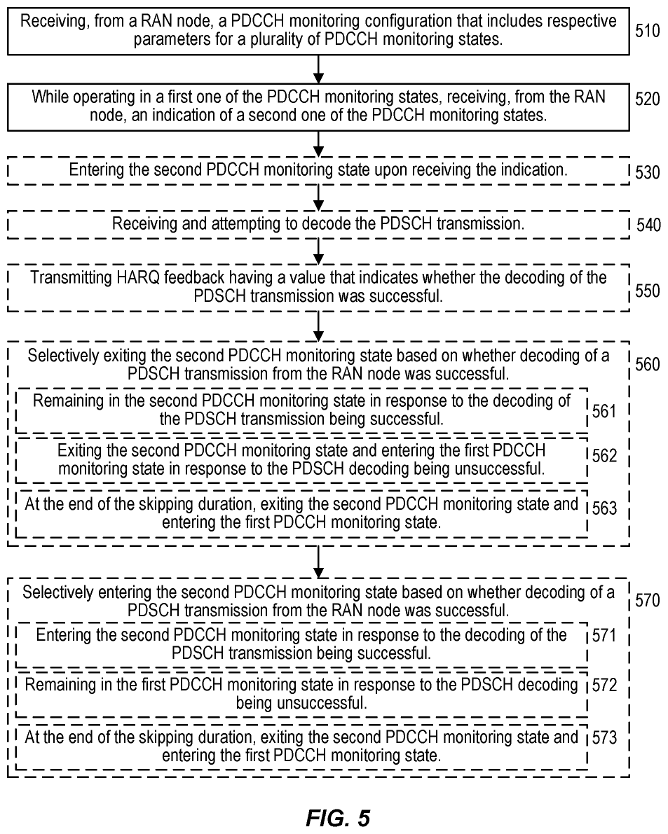

FIG. 3 shows an exemplary frequency-domain configuration for an NR UE. In Rel-15 NR, a UE can be configured with up to four carrier bandwidth parts (BWPs) in the DL with a single DL BWP being active at a given time. A UE can be configured with up to four BWPs in the UL with a single UL BWP being active at a given time. If a UE is configured with a supplementary UL, the UE can be configured with up to four additional BWPs in the supplementary UL, with a single supplementary UL BWP being active at a given time. In the exemplary arrangement of FIG. 5, the UE is configured with three DL (or UL) BWPs, labelled BWP 0-2, respectively.

Common RBs (CRBs) are numbered from 0 to the end of the carrier bandwidth. Each BWP configured for a UE has a common reference of CRB0 (as shown in FIG. 3), such that a configured BWP may start at a CRB greater than zero. CRB0 can be identified by one of the following parameters provided by the network:
PRB-index-DL-common for DL in a primary cell (PCell, e.g., PCell or PSCell);
PRB-index-UL-common for UL in a PCell;
PRB-index-DL-Dedicated for DL in a secondary cell (SCell);
PRB-index-UL-Dedicated for UL in an SCell; and
PRB-index-SUL-common for a supplementary UL.

In this manner, a UE can be configured with a narrow BWP (e.g., 10 MHz) and a wide BWP (e.g., 100 MHz), each starting at a particular CRB, but only one BWP can be active for the UE at a given point in time. In the arrangement shown in FIG. 5, BWPs 0-2 start at CRBs N⁰_{BWP}, N¹_{BWP}, and N²_{BWP}, respectively. Within a BWP, PRBs are defined and numbered in the frequency domain from 0 to N_{BWP,i}^{size}−1, where i is the index of the particular BWP for the carrier. In the arrangement shown in FIG. 5, BWPs 0-2 include PRBs 0 to N1, N2, and N3, respectively.

Similar to LTE, each NR resource element (RE) corresponds to one OFDM subcarrier during one OFDM symbol interval. NR supports various SCS values Δf=(15×2^{μ}) kHz, where μ∈(0, 1, 2, 3, 4) are referred to as “numerologies.” Numerology μ=0 (i.e., Δf=15 kHz) provides the basic (or reference) SCS that is also used in LTE. The symbol duration, cyclic prefix (CP) duration, and slot duration are inversely related to SCS or numerology. For example, there is one (1-ms) slot per subframe for Δf=15 kHz, two 0.5-ms slots per subframe for Δf=30 kHz, etc. In addition, the maximum carrier bandwidth is directly related to numerology according to 2^{μ}*50 MHz. Table 1 below summarizes the supported NR numerologies and associated parameters. Different DL and UL numerologies can be configured by the network.

TABLE 1

| | Δf = 2^{μ} · | Cyclic | CP | Symbol | Symbol + | Slot | | Max carrier |
|---|---|---|---|---|---|---|---|---|
| μ | 15 (kHz) | prefix (CP) | duration | duration | CP | duration | | BW |
| 0 | 15 | Normal | 4.69 μs | 66.67 μs | 71.35 μs | 1 | ms | 50 MHz |
| 1 | 30 | Normal | 2.34 μs | 33.33 μs | 35.68 μs | 0.5 | ms | 100 MHz |
| 2 | 60 | Normal, | 1.17 μs | 16.67 μs | 17.84 μs | 0.25 | ms | 200 MHz |
| | | Extended | | | | | | |
| 3 | 120 | Normal | 0.59 μs | 8.33 μs | 8.92 μs | 125 | μs | 400 MHz |
| 4 | 240 | Normal | 0.29 μs | 4.17 μs | 4.46 μs | 62.5 | μs | 800 MHz |

FIG. 4 shows an exemplary time-frequency resource grid for an NR slot. As illustrated in FIG. 4, a resource block (RB) consists of a group of 12 contiguous OFDM subcarriers for a duration of a 14-symbol slot. Similar to LTE, a resource element (RE) consists of one subcarrier in one slot. An NR slot can include 14 OFDM symbols for normal cyclic prefix and 12 symbols for extended cyclic prefix. An NR slot can also be arranged with various combinations of UL and DL symbols. Options can include DL-only slots (i.e., no UL transmission) with on-time (symbol 0) or late (symbol>0) starts, “DL-heavy” slots (e.g., one UL symbol), and “UL-heavy” slot with a single DL symbol carrying DL control information. Various guard periods before initial DL symbols (TUL-DL) and before initial UL symbols (TDL-UL) can also be used.

In addition, NR includes a Type-B scheduling, also known as “mini-slots.” These are shorter than slots, typically ranging from one symbol up to one less than the number of symbols in a slot (e.g., 11 or 13), and can start at any symbol of a slot. Mini-slots can be used if the transmission duration of a slot is too long and/or the occurrence of the next slot start (slot alignment) is too late. Applications of mini-slots include unlicensed spectrum and latency-critical transmission (e.g., URLLC). However, mini-slots are not service-specific and can also be used for eMBB or other services.

In NR, the physical downlink control channel (PDCCH) transmitted by a gNB is confined to a region containing a particular number of symbols and a particular number of subcarriers, referred to as the control resource set (CORESET). For example, the CORESET can include the first two symbols of a slot and each of the remaining 12 symbols can contain physical data channels (PDCH), i.e., either DL (PDSCH) or UL (PUSCH). Depending on specific CORESET configuration, however, the first two slots can also carry PDSCH or other information, as required.

A CORESET includes multiple RBs (i.e., multiples of 12 REs) in the frequency domain and 1-3 OFDM symbols in the time domain, as further defined in 3GPP TS 38.211 § 7.3.2.2. The smallest unit used for defining CORESET is resource element group (REG), which spans one PRB in frequency and one OFDM symbol in time. A CORESET is functionally similar to the control region in LTE subframe. In NR, however, each REG consists of all 12 REs of one OFDM symbol in an RB, whereas an LTE REG includes only four REs. Like in LTE, the CORESET time domain size can be indicated by the physical control format indicator (CFI) channel (PCFICH). In LTE, the frequency bandwidth of the control region is fixed (i.e., to the total system bandwidth), whereas in NR, the frequency bandwidth of the CORESET is variable. CORESET resources can be indicated to a UE by radio resource control (RRC) signaling.

In addition to PDCCH, each REG in a CORESET contains demodulation reference signals (DM-RS) to aid in the estimation of the radio channel over which that REG was transmitted. When transmitting the PDCCH, a precoder can be used to apply weights at the transmit antennas based on some knowledge of the radio channel prior to transmission. It is possible to improve channel estimation performance at the UE by estimating the channel over multiple REGs that are proximate in time and frequency, if the precoder used at the transmitter for the REGs is not different. To assist the UE with channel estimation, multiple REGs can be grouped together to form a REG bundle, and the REG bundle size for a CORESET (i.e., 2, 3, or 5 REGs) can be indicated to the UE. The UE can assume that any precoder used for the transmission of the PDCCH is the same for all the REGs in a REG bundle.

An NR control channel element (CCE) consists of six REGs. These REGs may either be contiguous or distributed in frequency. When the REGs are distributed in frequency, the CORESET is said to use interleaved mapping of REGs to a CCE, while if the REGs are contiguous in frequency, a non-interleaved mapping is said to be used. Interleaving can provide frequency diversity. Not using interleaving is beneficial for cases where knowledge of the channel allows the use of a precoder in a particular part of the spectrum improve the SINR at the receiver.

Similar to LTE, NR data scheduling can be performed dynamically, e.g., on a per-slot basis. In each slot, the base station (e.g., gNB) transmits downlink control information (DCI) over PDCCH that indicates which UE is scheduled to receive data in that slot, as well as which RBs will carry that data. A UE first detects and decodes DCI and, if the DCI includes DL scheduling information for the UE, receives the corresponding PDSCH based on the DL scheduling information. DCI formats 1_0 and 1_1 are used to convey PDSCH scheduling.

Likewise, DCI on PDCCH can include UL grants that indicate which UE is scheduled to transmit data on PUCCH in that slot, as well as which RBs will carry that data. A UE first detects and decodes DCI and, if the DCI includes an uplink grant for the UE, transmits the corresponding PUSCH on the resources indicated by the UL grant. DCI formats 0_0 and 0_1 are used to convey UL grants for PUSCH, while Other DCI formats (2_0, 2_1, 2_2 and 2_3) are used for other purposes including transmission of slot format information, reserved resource, transmit power control information, etc.

A DCI includes a payload complemented with a Cyclic Redundancy Check (CRC) of the payload data. Since DCI is sent on PDCCH that is received by multiple UEs, an identifier of the targeted UE needs to be included. In NR, this is done by scrambling the CRC with a Radio Network Temporary Identifier (RNTI) assigned to the UE. Most commonly, the cell RNTI (C-RNTI) assigned to the targeted UE by the serving cell is used for this purpose.

DCI payload together with an identifier-scrambled CRC is encoded and transmitted on the PDCCH. Given previously configured search spaces, each UE tries to detect a PDCCH addressed to it according to multiple hypotheses (also referred to as “candidates”) in a process known as “blind decoding.” PDCCH candidates span 1, 2, 4, 8, or 16 CCEs, with the number of CCEs referred to as the aggregation level (AL) of the PDCCH candidate. If more than one CCE is used, the information in the first CCE is repeated in the other CCEs. By varying AL, PDCCH can be made more or less robust for a certain payload size. In other words, PDCCH link adaptation can be performed by adjusting AL. Depending on AL, PDCCH candidates can be located at various time-frequency locations in the CORESET.

The link adaption algorithm within the gNB assigns a specific AL according to the size of the DCI payload and the UE coverage conditions. For example, small payloads can be accommodated using lower ALs while UEs experiencing poor coverage can be allocated higher ALs to allow increased channel coding gain via redundancy.

PDCCH is mapped onto a specific Search Space Set (SSS) according to the content of the DCI. For example, if the DCI is being used to provide a resource allocation (e.g., for MSG2) during random access, then the PDCCH is mapped onto a Type 1 Common SSS. Likewise, if the DCI is being used to provide a resource allocation for the transfer of application data, then the PDCCH is mapped onto a UE Specific SSS. Each SSS has a specific periodicity, which determines a UE's average waiting time for a resource allocation opportunity. Each SSS is mapped onto a specific CORESET.

A hashing function can be used to determine the CCEs corresponding to PDCCH candidates that a UE must monitor within an SSS. The hashing is done differently for different UEs. In this manner, CCEs used by the UEs are randomized and the probability of collisions between multiple UEs having messages included in a CORESET is reduced. Once a UE decodes a DCI, it de-scrambles the CRC with RNTI(s) that is(are) assigned to it and/or associated with the particular PDCCH search space. In case of a match, the UE considers the detected DCI as being addressed to it, and follows the instructions (e.g., scheduling information) in the DCI.

For example, to determine the modulation order, target code rate, and TB size(s) for a scheduled PDSCH transmission, the UE first reads the 5-bit modulation and coding scheme field (I_{MCS}) in the DCI (e.g., formats 1_0 or 1_1) to determine the modulation order (Qₘ) and target code rate (R) based on the procedure defined in 3GPP TS 38.214 V15.0.0 clause 5.1.3.1. Subsequently, the UE reads the redundancy version field (rv) in the DCI to determine the redundancy version. Based on this information together with the number of layers (U) and the total number of allocated PRBs before rate matching (nPRB), the UE determines the Transport Block Size (TBS) for the PDSCH according to the procedure defined in 3GPP TS 38.214 V15.0.0 clause 5.1.3.2. Similar techniques can be used by the UE for PUSCH transmission scheduled by DCI (e.g., formats 0_0 or 0_1).

Various PDCCH monitoring adaptations have been standardized and/or proposed within 3GPP. As one example, 3GPP Rel-16 includes a feature for NR unlicensed (NR-U) called search space set group (SSSG). In this feature, the UE receives an indication to switch from one SSSG to another SSSG and performs the switching in the first symbol of the first slot after several symbols of application delay, counted from the symbol when the indication was received by the UE. In other words, the UE applies the indicated SSSG after the application delay regardless of whether the UE successfully decodes the transmitted PDSCH.

Additionally, 3GPP Rel-17 includes a UE power-saving (UEPS) work item (WI). Within the scope of this WI, it has been agreed that reducing unnecessary PDCCH monitoring can be done through SSSG-switching and/or PDCCH skipping. For self-indication case (i.e., an indication received in a cell indicates the adaptation in that cell), it is agreed that at most two bits in the scheduling DCI can be used for the PDCCH monitoring adaptation.

In SSSG-switching, a UE can be configured with more than one (e.g., two) SSSGs and then indicated and/or controlled to switch between those SSSGs. For example, UE energy consumption can be reduced by configuring a first SSSG (e.g., SSSG0) to have sparse PDCCH monitoring occasions (MOs) and a second SSSG (e.g., SSSG1) to have dense PDCCH MOs. The UE monitors PDCCH according to the first SSSG when there is no data burst, switches to SSSG1 when a data burst comes, and then switches back to SSSG0 after the data burst ends.

In PDCCH skipping, a UE will be configured with one or more skipping durations. If the UE receives a skipping indication, the UE may skip PDCCH monitoring for the configured or indicated duration. When the skipping duration ends, the UE resumes monitoring PDCCH.

However, none of these PDCCH monitoring adaptations take HARQ status into consideration. For example, in a typical eMBB implementation, it may be beneficial to consider whether the UE successfully decoded the last PDSCH transmission before changing to a different PDCCH monitoring state (e.g., MO skipping or sparser MOs). For example, it may be preferable from an energy consumption and/or throughput perspective to not change PDCCH monitoring state if the UE did not correctly decode the last PDSCH transmission, since a retransmission is likely. Even so, it is unclear how to best take the HARQ and/or PDSCH decoding status into consideration, and whether different considerations are needed for different PDCCH monitoring adaptations (e.g., PDCCH skipping vs. SSSG switching).

Accordingly, embodiments of the present disclosure provide flexible and efficient techniques for PDCCH monitoring state transitions based on HARQ status. For example, when a UE receives an indication for a PDCCH monitoring state transition (e.g., PDCCH skipping, SSSG switching, etc.), the UE may perform, forego, or delay the indicated PDCCH monitoring state transition based on whether the UE successfully decoded a most recent PDSCH transmission. As a more specific example, when the UE is indicated to switch SSSGs, the UE can delay monitoring PDCCH according to the indicated SSSG until after the UE successfully decodes PDSCH. The indication for a PDCCH monitoring state transition may be implicit through the indication of the PDCCH monitoring state to transition to.

Embodiments of the present disclosure can provide various benefits and/or advantages. For example, embodiments facilitate reduced UE energy consumption via PDCCH monitoring state transitions, while reducing and/or minimizing the impact of such transitions on data throughput and/or latency. This can benefit applications and end users by providing increased UE battery life (i.e., between charges) and more consistent data throughput.

In the following, “PDCCH monitoring state transition” refers to SSSG switching, PDCCH skipping, or any other technique in which a UE transitions between multiple PDCCH monitoring states that result in different levels of UE energy consumption.

In the following, “directly apply” is used to mean applying as soon as technical feasible and/or applying after a baseline application or processing delay, which may be specified by 3GPP or configured by the network in the UE.

In the following, “PDCCH monitoring configuration” refers to a configuration including respective parameters for multiple PDCCH monitoring states, such as multiple PDCCH skipping durations (including no skipping) and/or multiple SSSGs. One of the PDCCH monitoring states may be a default PDCCH monitoring state. After providing a PDCCH monitoring configuration to a UE, a network can then indicate for the UE to use a particular one of the PDCCH monitoring states from the PDCCH monitoring configuration.

A PDCCH monitoring configuration may apply to a single cell or to multiple cells, as long as the UE and the network have a common understanding of this applicability. Likewise, an indicated PDCCH monitoring state may apply to a single cell or to multiple cells, as long as the UE and the network have a common understanding of this applicability.

In some embodiments, a UE can receive from the network a PDCCH monitoring configuration for at least one cell. The PDCCH monitoring configurations can include parameters related to one or more of PDCCH skipping, SSSG switching, and any other relevant multi-state PDCCH monitoring techniques. For SSSG switching, the PDCCH monitoring configuration can include a plurality of indices corresponding to a plurality of configured search space sets (SSS). For PDCCH skipping, the PDCCH monitoring configuration can include a plurality of skipping durations (including no skipping).

The maximum number of PDCCH monitoring states that can be represented by a PDCCH monitoring configuration may depend on number of bits in a bitfield used to indicate a particular PDCCH monitoring state for the UE, as well as how different values (or codepoints) of the bitfield are interpreted. For example, when two bits are available for indication of PDCCH monitoring state, the UE can be configured with up to four PDCCH skipping durations (including no skipping) as long as SSSG switching is not configured. On the other hand, when the UE is configured with both SSSG switching and PDCCH skipping and when two bits are available for indication, the UE may be configured with two PDCCH-skipping durations and two SSSGs for switching.

After receiving the PDCCH monitoring configuration, the UE can receive from the network an indication of a particular one of the PDCCH monitoring states represented by the PDCCH monitoring configuration. For example, the network can send a DCI that includes the bitfield mentioned above, having a particular value (or codepoint) that corresponds to one of the PDCCH monitoring states. The indication for a PDCCH monitoring state transition may thus be implicit through the indication of a particular one of the PDCCH monitoring states that the UE is to transition to.

The UE may be operating in a first PDCCH monitoring state (e.g., default or previously indicated) before receiving the DCI, and the received DCI indicates a second PDCCH monitoring state. For example, if the PDCCH monitoring configuration includes two SSSGs (e.g., SSSG0 and SSSG1), the respective values (0 and 1) of a single bit in the DCI can indicate the respective SSSGs. In another example, four values of a two-bit field can indicate three PDCCH skipping durations (e.g., X1, X2, X3) and no skipping. In another example, if the PDCCH monitoring configuration includes two SSSGs (e.g., SSSG0, SSSG1) and two skipping durations (e.g., X1, X2), four values of a two-bit field can indicate SSSG0, SSSG1, skipping PDCCH monitoring for X1, and skipping PDCCH monitoring for X2.

After receiving the indication of a particular PDCCH monitoring state of the PDCCH monitoring configuration, the UE can apply the indicated PDCCH monitoring state. For example, when the UE is indicated to skip PDCCH monitoring for X1 duration, the UE may directly apply the indication and skip PDCCH monitoring for an X1 duration. In another example, when the UE is currently monitoring PDCCH according to SSSG0 and is indicated to switch to SSSG1, the UE may directly switch to monitoring PDCCH according to SSSG1. In another example, the UE may switch from an SSSG with sparse PDCCH MOs to an SSSG with dense PDCCH MOs based on the indication.

In some embodiments, the indication can be included in a DCI that also includes scheduling information for a DL transmission (e.g., of a transport block (TB)) for the UE on PDSCH. Based on the scheduling information, the UE receives and decodes the PDSCH and transmits UL HARQ feedback based on the result of the PDSCH decoding. For example, the UE transmits ACK when it successfully decodes the PDSCH and NACK when the decoding was unsuccessful.

In some embodiments, the UE can continue in the indicated PDCCH monitoring state regardless of whether the PDSCH decoding was successful and/or whether the UE transmitted ACK or NACK. In other embodiments, the UE can determine whether to continue in the indicated PDCCH monitoring state based on the result of the PDSCH decoding. For example, if the indicated PDCCH monitoring state was PDCCH skipping with duration X1, the UE can resume and/or remain in PDCCH skipping for the remainder of X1 based on successfully decoding PDSCH. On the other hand, if the UE does not successfully decode PDSCH (and transmits NACK), the UE may cancel PDCCH skipping and return to its previous PDCCH monitoring state (e.g., no skipping) before receiving the indication.

In some embodiments, the UE may wait for a cancellation delay before returning to its previous PDCCH monitoring state. For example, the UE can return to the previous PDCCH monitoring state at the first symbol of the first slot after the NACK transmission. In another example, the UE may return to the previous PDCCH monitoring state m slots or m symbols after transmitting NACK, e.g., the m-th symbol after the symbol in which NACK was transmitted. The value of m can be preconfigured (or specified) in 3GPP standards or can be configured for the UE by the network.

The following example further illustrates these embodiments. In this example, the UE receives a PDCCH DCI that schedules PDSCH in slot x. The PDCCH DCI also includes a bitfield indicating that the UE should skip PDCCH monitoring for a predefined skipping duration of X1 slots. Based on this indication, the UE starts skipping PDCCH monitoring from a starting point at slot x+1, which can be the next DL slot or a next slot after x.

If the UE successfully decodes the PDSCH in slot x, the UE transmits an ACK in slot y>x, and continues skipping PDCCH monitoring until slot x+X1 (assuming x1+X1>y). On the other hand, if the UE does not successfully decode the PDSCH in slot x, it transmits a NACK in slot y and instead of skipping, it monitors PDCCH in at least some of the slots during [y, x+X1]. This allows the UE to be scheduled with a retransmission for the PDSCH that was not decoded successfully.

In the embodiments described above, the UE applies the indicated PDCCH monitoring state directly and then later determines whether to continue in the indicated PDCCH monitoring state or to return to the previous PDCCH monitoring state based on the result of decoding the PDSCH that was scheduled with the indication. In a variant, the UE can remain in its current (i.e., pre-indication) PDCCH monitoring state until PDSCH decoding is complete and then selectively apply the indicated PDCCH monitoring state based on the result of PDSCH decoding.

For example, if the indicated PDCCH monitoring state is PDCCH skipping with duration X1, the UE can begin PDCCH skipping after successfully decoding PDSCH (e.g., a predetermined delay later) and continue for duration X1. On the other hand, if the UE does not successfully decode PDSCH (and transmits NACK), the UE can forego PDCCH skipping and remain in its current PDCCH monitoring state (e.g., no PDCCH skipping) in use before receiving the indication.

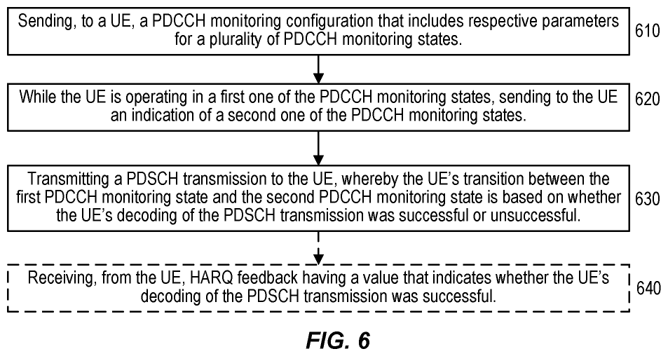

Various features of the embodiments described above correspond to various operations illustrated in FIGS. 5-6, which show exemplary methods (e.g., procedures) for a UE and a RAN node, respectively. In other words, various features of the operations described below correspond to various embodiments described above. Furthermore, the exemplary methods shown in FIGS. 5-6 can be used cooperatively to provide various benefits, advantages, and/or solutions to problems described herein. Although FIGS. 5-6 show specific blocks in particular orders, the operations of the exemplary methods can be performed in different orders than shown and can be combined and/or divided into blocks having different functionality than shown. Optional blocks or operations are indicated by dashed lines.

In particular, FIG. 5 shows an exemplary method (e.g., procedure) for a UE configured for operation in a radio access network (RAN), according to various embodiments of the present disclosure. The exemplary method can be performed by a UE (e.g., wireless device, etc.) such as described elsewhere herein.

The exemplary method can include the operations of block 510, where the UE can receive, from a RAN node, a PDCCH monitoring configuration that includes respective parameters for a plurality of PDCCH monitoring states. The exemplary method can also include the operations of block 520, where the UE can, while operating in a first one of the PDCCH monitoring states, receive from the RAN node an indication of a second one of the PDCCH monitoring states. In embodiments, the indication indicates a transition to the second one of the PDCCH monitoring states. The exemplary methods can also include one of the following operations (denoted by corresponding block numbers):
(block 560) selectively exiting the second PDCCH monitoring state based on whether decoding of the PDSCH transmission from the RAN node was successful, or
(block 570) selectively entering the second PDCCH monitoring state based on whether decoding of a physical downlink shared channel (PDSCH) transmission from the RAN node was successful.

In some embodiments, the indication is received in downlink control information (DCI) and the DCI also includes scheduling information for the PDSCH transmission. In some variants, the configuration is received in a radio resource control (RRC) message.

In some embodiments, the PDCCH monitoring configuration is applicable to one of the following: only the cell in which the PDCCH monitoring configuration was received; or a plurality of cells served by the RAN node, including the cell in which the PDCCH monitoring configuration was received.

In some embodiments, the parameters for each of the PDCCH monitoring states includes one or more of the following: a skipping duration to refrain from PDCCH monitoring; and a search space set group (SSSG) to use for PDCCH monitoring. In some variants, the indication may be an index or a bitfield that can have one of a plurality of values that respectively correspond to one of the following:
a plurality of different SSSGs (e.g., two bits indicating four different SSGs);
a plurality of different skipping durations (e.g., two bits indicating four different skipping durations); or
a first plurality of different SSSGs (e.g., one bit indicating two different SSGs) and a second plurality of different skipping durations (e.g., one bit indicating two different skipping durations).
   In some variants, one of the different skipping durations is no skipping of PDCCH monitoring.

In some embodiments, the exemplary method can also include the operations of blocks 540-550, where the UE can receive and attempt to decode the PDSCH transmission, and transmit HARQ feedback having a value that indicates whether the decoding of the PDSCH transmission was successful.

In some embodiments including the operations of block 560, the exemplary method can also include the operations of block 530, where the UE can enter the second PDCCH monitoring state upon receiving the indication. In such embodiments, selectively exiting the second PDCCH monitoring state in block 560 can include the following operations of sub-blocks 561-562:
remaining in the second PDCCH monitoring state in response to the decoding of the PDSCH transmission being successful; and
exiting the second PDCCH monitoring state and entering the first PDCCH monitoring state in response to the PDSCH decoding being unsuccessful.
   In some of these embodiments, exiting the second PDCCH monitoring state and entering the first PDCCH monitoring state occurs a predetermined delay after transmitting the HARQ feedback.

In some of these embodiments, the second PDCCH monitoring state includes a skipping duration and remaining in the second PDCCH monitoring state (e.g., in sub-block 561) is until the end of the skipping duration. Additionally, selectively exiting the second PDCCH monitoring state (e.g., in block 560) also includes the operations of sub-block 563, where the UE can, at the end of the skipping duration, exit the second PDCCH monitoring state and enter the first PDCCH monitoring state.

In other embodiments including the operations of block 570, selectively entering the second PDCCH monitoring state can include the following operations of sub-blocks 571-572:
entering the second PDCCH monitoring state in response to the decoding of the PDSCH transmission being successful; and
remaining in the first PDCCH monitoring state in response to the PDSCH decoding being unsuccessful.
   In some of these embodiments, entering the second PDCCH monitoring state occurs a predetermined delay after transmitting the HARQ feedback.

In some of these embodiments, the second PDCCH monitoring state includes a skipping duration and selectively entering the second PDCCH monitoring state (e.g., in block 570) also includes the operations of sub-block 573, where the UE can, at the end of the skipping duration, exit the second PDCCH monitoring state and enter the first PDCCH monitoring state.

In addition, FIG. 6 shows an exemplary method (e.g., procedure) for a RAN node configured to communicate with UEs, according to various embodiments of the present disclosure. The exemplary method can be performed by a RAN node (e.g., base station, eNB, gNB, en-gNB, etc.) such as described elsewhere herein.

The exemplary method can include the operations of block 610, where the RAN node can send, to a UE, a physical downlink control channel (PDCCH) monitoring configuration that includes respective parameters for a plurality of PDCCH monitoring states. The exemplary method can include the operations of block 620, where the RAN node can, while the UE is operating in a first one of the PDCCH monitoring states, send to the UE an indication of a second one of the PDCCH monitoring states. The exemplary method can include the operations of block 630, where the RAN node can transmit a PDSCH transmission (e.g., TB) to the UE. The UE's transition between the first PDCCH monitoring state and the second PDCCH monitoring state is based on whether the UE's decoding of the PDSCH transmission is successful or unsuccessful.

In some embodiments, the indication is sent in DCI, and the DCI also includes scheduling information for the PDSCH transmission. In some variants, the configuration is received in an RRC message. In some embodiments, the PDCCH monitoring configuration is applicable to one of the following: only the cell in which the PDCCH monitoring configuration was received; or a plurality of cells served by the RAN node, including the cell in which the PDCCH monitoring configuration was received.

In some embodiments, the parameters for each of the PDCCH monitoring states includes one or more of the following: a skipping duration to refrain from PDCCH monitoring; and a search space set group (SSSG) to use for PDCCH monitoring. In some variants, the indication may be an index or a bitfield that can have one of a plurality of values that respectively correspond to one of the following:
a plurality of different SSSGs (e.g., two bits indicating four different SSGs);
a plurality of different skipping durations (e.g., two bits indicating four different skipping durations); or
a first plurality of different SSSGs (e.g., one bit indicating two different SSGs) and a second plurality of different skipping durations (e.g., one bit indicating two different skipping durations).
   In some variants, one of the different skipping durations is no skipping of PDCCH monitoring.

In some embodiments, the exemplary method can also include the operation of block 640, where the RAN node can receive, from the UE, HARQ feedback having a value that indicates whether the UE's decoding of the PDSCH was successful.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

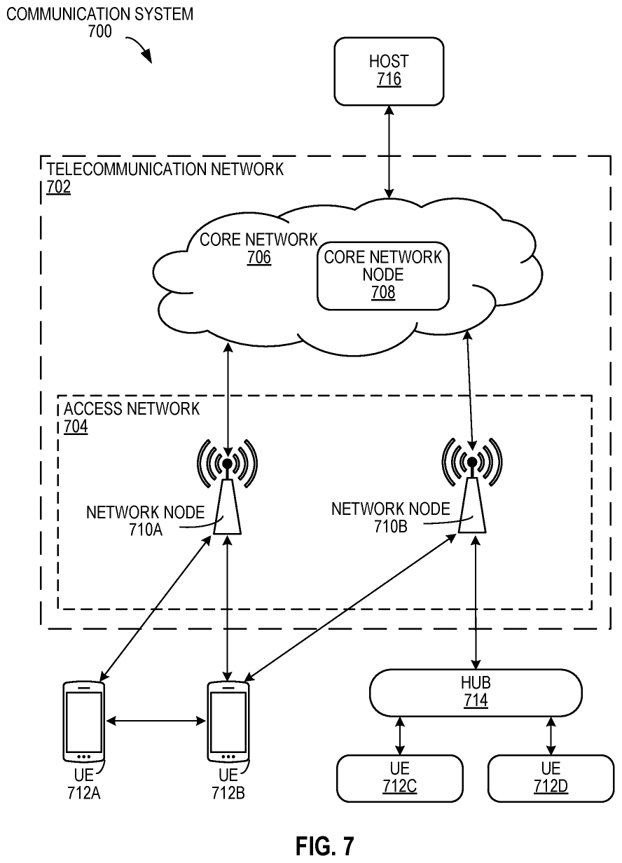

FIG. 7 shows an example of a communication system 700 in accordance with some embodiments. In this example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3P Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

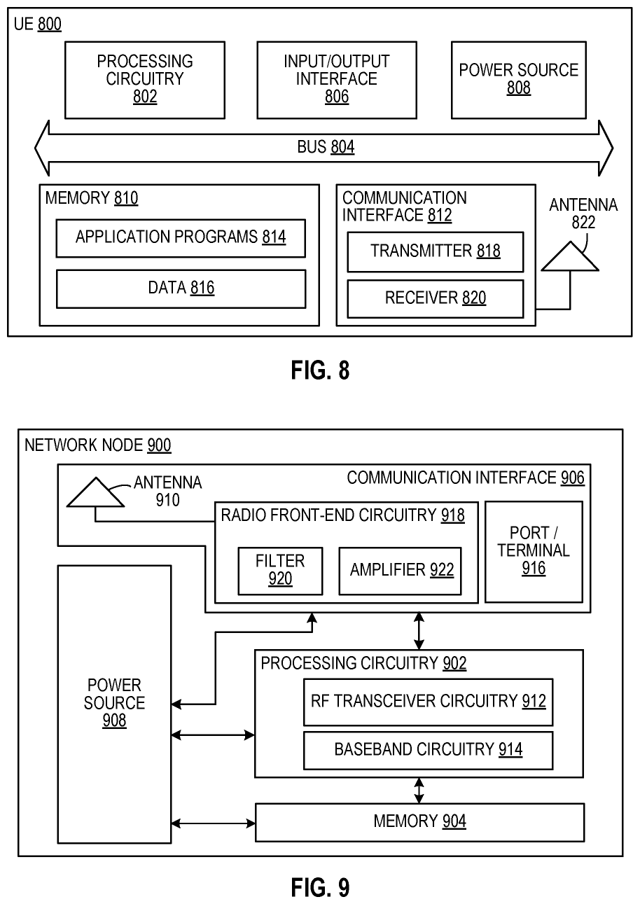

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

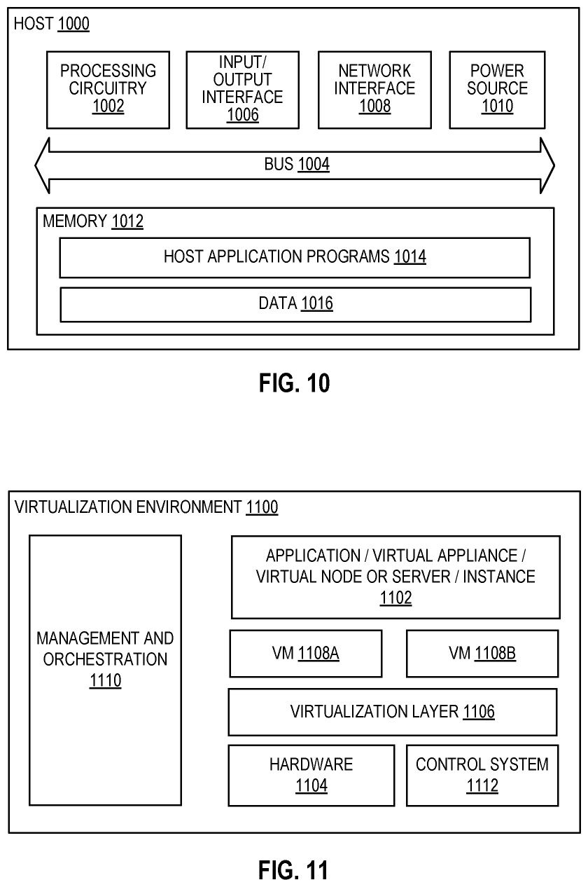

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

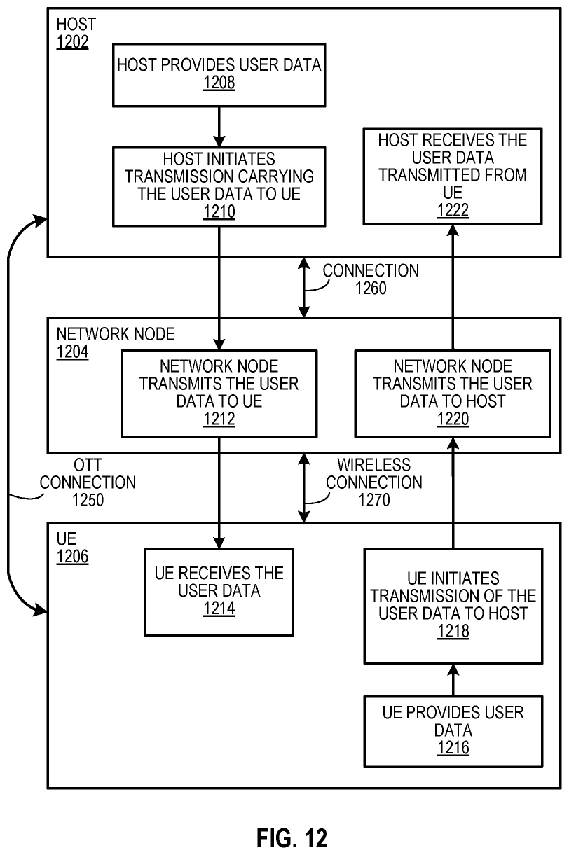

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, embodiments described herein can facilitate reduced UE energy consumption via PDCCH monitoring state transitions, while reducing and/or minimizing the impact of such transitions on data throughput and/or latency. This can benefit applications and end users by providing increased UE battery life (i.e., between charges) and more consistent data throughput. Consequently, when used in UEs and networks that deliver OTT data services to end users, embodiments increase the value of the OTT data services to the end users and to service providers.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### Example Embodiments

A1. A method for a user equipment (UE) configured to operate in a radio access network (RAN), the method comprising:
receiving, from a RAN node, a physical downlink control channel (PDCCH) monitoring configuration that includes respective parameters for a plurality of PDCCH monitoring states;
while operating in a first one of the PDCCH monitoring states, receiving, from the RAN node, an indication of a second one of the PDCCH monitoring states; and
performing one of the following:
   selectively entering the second PDCCH monitoring state based on whether decoding of a physical downlink shared channel (PDSCH) transmission from the RAN node was successful, or
   selectively exiting the second PDCCH monitoring state based on whether decoding of the PDSCH transmission from the RAN node was successful.
      A2. The method of embodiment A1, wherein:
the indication is received in downlink control information (DCI); and
the DCI also includes scheduling information for the PDSCH transmission.
   A2a. The method of embodiment A2, wherein the configuration is received in a radio resource control (RRC) message.
   A2b. The method of any of embodiments A1-A2a, wherein the first PDCCH monitoring state is a default PDCCH monitoring state.
   A2c. The method of any of embodiments A1-A2b, wherein the PDCCH monitoring configuration is applicable to one of the following:
only the cell in which the PDCCH monitoring configuration was received; or
a plurality of cells served by the RAN node, including the cell in which the PDCCH monitoring configuration was received.
   A3. The method of any of embodiments A1-A2c, wherein the parameters for each of the PDCCH monitoring states includes one or more of the following:
a skipping duration to refrain from PDCCH monitoring; and
a search space set group (SSSG) to use for PDCCH monitoring.
   A4. The method of embodiment A3, wherein the indication is an index that can have one of a plurality of values that respectively correspond to one of the following:
a plurality of different SSSGs;
a plurality of different skipping durations; or
a first plurality of different SSSGs and a second plurality of different skipping durations.
   A5. The method of embodiment A4, wherein one of the different skipping durations is no skipping of PDCCH monitoring.
   A6. The method any of embodiments A1-A5, further comprising:
receiving and attempting to decode the PDSCH transmission; and
transmitting hybrid ARQ (HARQ) feedback having a value that indicates whether the decoding of the PDSCH transmission was successful.
   A7. The method of embodiment A6, wherein:
the method further comprises entering the second PDCCH monitoring state upon receiving the indication; and
selectively exiting the second PDCCH monitoring state comprises:
   remaining in the second PDCCH monitoring state in response to the decoding of the PDSCH transmission being successful; and
   exiting the second PDCCH monitoring state and entering the first PDCCH monitoring state in response to the PDSCH decoding being unsuccessful.
      A8. The method of embodiment A7, wherein exiting the second PDCCH monitoring state and entering the first PDCCH monitoring state occurs a predetermined delay after transmitting the HARQ feedback.
      A9. The method of any of embodiments A7-A8, wherein:
the second PDCCH monitoring state includes a skipping duration; and
remaining in the second PDCCH monitoring state is until the end of the skipping duration; and
selectively exiting the second PDCCH monitoring state further comprises, at the end of the skipping duration, exiting the second PDCCH monitoring state and entering the first PDCCH monitoring state.
   A10. The method of embodiment A6, wherein selectively entering the second PDCCH monitoring state comprises:
entering the second PDCCH monitoring state in response to the decoding of the PDSCH transmission being successful; and
remaining in the first PDCCH monitoring state in response to the PDSCH decoding being unsuccessful.
   A11. The method of embodiment A10, wherein entering the second PDCCH monitoring state occurs a predetermined delay after transmitting the HARQ feedback.
   A12. The method of any of embodiments A10-A11, wherein:
the second PDCCH monitoring state includes a skipping duration; and
selectively entering the second PDCCH monitoring state further comprises, at the end of the skipping duration, exiting the second PDCCH monitoring state and entering the first PDCCH monitoring state.
   B1. A method for a radio access network (RAN) node configured to communicate with user equipment (UEs), the method comprising:
sending, to a UE, a physical downlink control channel (PDCCH) monitoring configuration that includes respective parameters for a plurality of PDCCH monitoring states;
while the UE is operating in a first one of the PDCCH monitoring states, sending to the UE an indication of a second one of the PDCCH monitoring states; and
transmitting a physical downlink shared channel (PDSCH) transmission to the UE, whereby the UE's transition between the first PDCCH monitoring state and the second PDCCH monitoring state is based on whether the UE's decoding of the PDSCH transmission was successful or unsuccessful.
   B2. The method of embodiment B1, wherein:
the indication is sent in downlink control information (DCI); and
the DCI also includes scheduling information for the PDSCH transmission.
   B3. The method of embodiment B2, wherein the configuration is sent in a radio resource control (RRC) message.
   B4. The method of any of embodiments B1-B3, wherein the first PDCCH monitoring state is a default PDCCH monitoring state.
   B5. The method of any of embodiments B1-B4, wherein the PDCCH monitoring configuration is applicable to one of the following:
only the cell in which the PDCCH monitoring configuration was sent; or
a plurality of cells served by the RAN node, including the cell in which the PDCCH monitoring configuration was sent.
   B6. The method of any of embodiments B1-B5, wherein the parameters for each of the PDCCH monitoring states includes one or more of the following:
a skipping duration to refrain from PDCCH monitoring; and
a search space set group (SSSG) to use for PDCCH monitoring.
   B7. The method of embodiment B6, wherein the indication is an index that can have one of a plurality of values that respectively correspond to one of the following:
a plurality of different SSSGs;
a plurality of different skipping durations; or
a first plurality of different SSSGs and a second plurality of different skipping durations.
   B8. The method of embodiment B7, wherein one of the different skipping durations is no skipping of PDCCH monitoring.
   B9. The method any of embodiments B1-B8, further comprising receiving, from the UE, hybrid ARQ (HARQ) feedback having a value that indicates whether the UE's decoding of the PDSCH was successful.
   C1. A user equipment (UE) configured for operation in a radio access network (RAN), the UE comprising:
communication interface circuitry configured to communicate with a RAN node; and
processing circuitry operatively coupled to the communication interface circuitry, whereby the processing circuitry and the communication interface circuitry are configured to perform operations corresponding to any of the methods of embodiments A1-A12.
   C2. A user equipment (UE) configured for operation in a radio access network (RAN), the UE being further configured to perform operations corresponding to any of the methods of embodiments A1-A12.
   C3. A non-transitory, computer-readable medium storing computer-executable instructions that, when executed by processing circuitry of a user equipment (UE) configured for operation in a radio access network (RAN), configure the UE to perform operations corresponding to any of the methods of embodiments A1-A12.
   C4. A computer program product comprising computer-executable instructions that, when executed by processing circuitry of a user equipment (UE) configured for operation in a radio access network (RAN), configure the UE to perform operations corresponding to any of the methods of embodiments A1-A12.
   D1. A radio access network (RAN) node configured to communicate with user equipment (UEs), the RAN node comprising:
communication interface circuitry configured to communicate with the UEs; and
processing circuitry operatively coupled to the communication interface circuitry, whereby the processing circuitry and the communication interface circuitry are configured to perform operations corresponding to any of the methods of embodiments B1-B9.
   D2. A radio access network (RAN) node configured to communicate with user equipment (UEs), the RAN node being further configured to perform operations corresponding to any of the methods of embodiments B1-B9.
   D3. A non-transitory, computer-readable medium storing computer-executable instructions that, when executed by processing circuitry of a radio access network (RAN) node configured to communicate with user equipment (UEs), configure the RAN node to perform operations corresponding to any of the methods of embodiments B1-B9.
   D4. A computer program product comprising computer-executable instructions that, when executed by processing circuitry of a radio access network (RAN) node configured to communicate with user equipment (UEs), configure the RAN node to perform operations corresponding to any of the methods of embodiments B1-B9.

1.-35. (canceled)

36. A method for a user equipment (UE) configured to operate in a radio access network (RAN), the method comprising:
receiving, from a RAN node, a physical downlink control channel (PDCCH) monitoring configuration that includes respective parameters for a plurality of PDCCH monitoring states, including first and second PDCCH monitoring states;
while operating in the first PDCCH monitoring state, receiving from the RAN node an indication of the second PDCCH monitoring state;
entering the second PDCCH monitoring state upon receiving the indication;
receiving and attempting to decode a physical downlink shared channel (PDSCH) transmission from the RAN node;
selectively exiting the second PDCCH monitoring state based on whether decoding of the PDSCH transmission was successful, wherein the selectively exiting comprises:
remaining in the second PDCCH monitoring state in response to the decoding of the PDSCH transmission being successful; and
exiting the second PDCCH monitoring state and entering the first PDCCH monitoring state in response to the PDSCH decoding being unsuccessful.

37. The method of claim 36, wherein:
the indication is received in downlink control information (DCI); and
the DCI also includes scheduling information for the PDSCH transmission.

38. The method of claim 36, wherein the first PDCCH monitoring state is a default PDCCH monitoring state.

39. The method of claim 36, wherein the PDCCH monitoring configuration is applicable to one of the following:
only the cell in which the PDCCH monitoring configuration was received; or
a plurality of cells served by the RAN node, including the cell in which the PDCCH monitoring configuration was received.

40. The method of claim 36, wherein the parameters for each of the PDCCH monitoring states includes one or more of the following:
a skipping duration to refrain from PDCCH monitoring; and
a search space set group (SSSG) to use for PDCCH monitoring.

41. The method of claim 36, further comprising transmitting hybrid ARQ (HARQ) feedback having a value that indicates whether the decoding of the PDSCH transmission was successful or unsuccessful.

42. The method of claim 41, wherein exiting the second PDCCH monitoring state and entering the first PDCCH monitoring state occurs a predetermined delay after transmitting the HARQ feedback.

43. The method of claim 42, wherein entering the first PDCCH monitoring state occurs at the first symbol of the first slot after transmitting the HARQ feedback.

44. The method of claim 36, wherein:
the second PDCCH monitoring state includes a skipping duration; and
remaining in the second PDCCH monitoring state is until the end of the skipping duration; and
selectively exiting the second PDCCH monitoring state further comprises, at the end of the skipping duration, exiting the second PDCCH monitoring state and entering the first PDCCH monitoring state.

45. A method for a radio access network (RAN) node configured to communicate with user equipment (UE), the method comprising:
sending, to a UE, a physical downlink control channel (PDCCH) monitoring configuration that includes respective parameters for a plurality of PDCCH monitoring states, including first and second PDCCH monitoring states;
while the UE is operating in the first PDCCH monitoring state, sending to the UE an indication of the second PDCCH monitoring state; and
transmitting a physical downlink shared channel (PDSCH) transmission to the UE, wherein the UE's transition between the first PDCCH monitoring state and the second PDCCH monitoring state is based on whether the UE's decoding of the PDSCH transmission is successful or unsuccessful.

46. The method of claim 45, wherein:
the indication is sent in downlink control information (DCI); and
the DCI also includes scheduling information for the PDSCH transmission.

47. The method of claim 45, wherein the first PDCCH monitoring state is a default PDCCH monitoring state.

48. The method of claim 45, wherein the PDCCH monitoring configuration is applicable to one of the following:
only the cell in which the PDCCH monitoring configuration was sent; or
a plurality of cells served by the RAN node, including the cell in which the PDCCH monitoring configuration was sent.

49. The method of claim 45, wherein the parameters for each of the plurality of PDCCH monitoring states includes one or more of the following:
a skipping duration to refrain from PDCCH monitoring; and
a search space set group (SSSG) to use for PDCCH monitoring.

50. The method of claim 45, further comprising receiving, from the UE, hybrid ARQ (HARQ) feedback having a value that indicates whether the UE's decoding of the PDSCH was successful or unsuccessful.

51. The method of claim 45, wherein the UE's transition between the first PDCCH monitoring state and the second PDCCH monitoring state is further based on the UE's reception of the indication of the second PDCCH monitoring state.

52. A user equipment (UE) configured for operation in a radio access network (RAN), the UE comprising:
communication interface circuitry configured to communicate with a RAN node; and
processing circuitry operatively coupled to the communication interface circuitry, wherein the processing circuitry and the communication interface circuitry are configured to perform the method of claim 36.

53. A non-transitory, computer-readable medium storing computer-executable instructions that, when executed by processing circuitry of a user equipment (UE) configured for operation in a radio access network (RAN), configure the UE to perform the method of claim 36.

54. A radio access network (RAN) node configured to communicate with user equipment (UE), the RAN node comprising:
communication interface circuitry configured to communicate with the UEs; and
processing circuitry operatively coupled to the communication interface circuitry, wherein the processing circuitry and the communication interface circuitry are configured to perform the method of claim 45.

55. A non-transitory, computer-readable medium storing computer-executable instructions that, when executed by processing circuitry of a radio access network (RAN) node configured to communicate with user equipment (UE), configure the RAN node to perform the method of claim 45.
